(19) United States
(12) Patent Application Publication
(10) Pub. No.: US 2018/0162487 A1
(43) Pub. Date: Jun. 14, 2018

(54) CRANK ASSEMBLY

(71) Applicant: Shu-Chiung CHANG, Taichung (TW)

(72) Inventor: Shu-Chiung CHANG, Taichung (TW)

(21) Appl. No.: 15/377,771

(22) Filed: Dec. 13, 2016

(51) Int. Cl. B62M 9/16; B62M 3/00; B62M 3/16

(52) U.S. Cl. CPC B62M 9/16; B62M 9/105; B62M 3/16; B62M 3/00

(57) ABSTRACT

A crank assembly for a bicycle includes a crank arm, multiple first and second securing members, and a sprocket unit having small, medium, and large sprockets. The small sprocket includes a toothed ring and multiple first fastening pieces. The medium sprocket includes a toothed ring, multiple second and third fastening pieces, and multiple spacing-adjustment pieces each extending obliquely and interconnecting a respective one of the second fastening pieces and a respective one of the third fastening pieces. The large sprocket includes a toothed ring and multiple fourth fastening pieces. The first securing members secure the small and medium sprockets to the crank arm. The second securing members secure the large sprocket to the medium sprocket.

### FIELD

The disclosure relates to a component of a bicycle, and more particularly to a crank assembly including a crank arm and a sprocket unit.

### BACKGROUND

Referring to FIG. 1, a conventional bicycle frame 10 includes an bottom bracket shell 11, a seat tube 12 that is fixedly connected to the bottom bracket shell 11, a down tube 13 and a dual chain stay 14 that are fixedly connected to the bottom bracket shell 11 and a bottom end portion of the seat tube 12, a top tube 15 and a dual seat stay 16 that are fixedly connected to a top end portion of the seat tube 12, and a head tube 17 that interconnects the down tube 13 and the top tube 15. The bottom bracket shell 11, the seat tube 12, the down tube 13, and the dual chain stay 14 constitute an important part of the conventional bicycle frame 10 for bicycle safety. As shown in FIG. 2, a spindle 18 is disposed in the bottom bracket shell 11 along an axis (X), and has two opposite ends along the axis (X). One of the opposite ends is coupled with a conventional crank assembly 20 to which a pedal (not shown) is attached, and the other one of the opposite ends is coupled to a crank arm (not shown) to which another pedal is attached. When a rider pedals, the bicycle can move forward.

The conventional crank assembly 20 in FIG. 2 is disclosed in U.S. Pat. No. 5,217,413, and includes a crank arm 21 and a sprocket unit 22 securely connected to the crank arm 21. The sprocket unit 22 includes a small sprocket 23, a medium sprocket 24, and a large sprocket 25 that are secure fixedly to the crank arm 21. The sprocket unit 22 can cooperate with a rear derailleur gear (not shown) to provide different gear ratios for different riding conditions.

For various bicycle designs, sizes of the components of the bicycle have to meet established safety standards or specifications. For example, with an increase in diameters and lengths of the bottom bracket shell 11 and of the spindle 18, a distance between any one of the small, medium, and large sprockets 23, 24, 25 and an imaginary plane (A) which passes through a center point 181 of the spindle 18 and which is normal to the axis (X) has to be changed accordingly in order to be in compliance with the safety standards. However, distances between the small, medium, and large sprockets 23, 24, 25 are fixed and cannot be changed to meet the safety standards. Therefore, the sprocket unit 22 cannot be applied to various bicycle designs. In addition, since the size of the sprocket unit 22 is fixed, some manufacturers may change the shapes or sizes of other components of the bicycle without following the safety standards, which not only adversely affects structural safety of the bicycle but also creates safety concerns for the rider.

### SUMMARY

Therefore, an object of the disclosure is to provide a crank assembly that can alleviate at least one of the drawbacks of the prior art.

According to the disclosure, the crank assembly is for a bicycle. The bicycle includes a spindle that extends along an axis, and that has a center point on the axis and two opposite connecting segments along the axis. The crank assembly includes a crank arm, a sprocket unit, and a plurality of first and second securing members.

The crank arm is adapted to be mounted to one of the connecting segments of the spindle.

The sprocket unit includes a small sprocket, a medium sprocket, and a large sprocket. The small sprocket includes a small toothed ring surrounding the axis, and a plurality of first fastening pieces connected to the small toothed ring and extending toward the axis. The medium sprocket includes a medium toothed ring surrounding the axis, a plurality of second fastening pieces extending from the medium toothed ring toward the axis, a plurality of third fastening pieces surrounding the axis, and a plurality of spacing-adjustment pieces each interconnecting a respective one of the second fastening pieces and a respective one of the third fastening pieces. The second fastening pieces and the third fastening pieces are respectively distal from and proximate to the axis. A distance between the second fastening pieces and an imaginary plane passing through the center point of the spindle and being normal to the axis is different from that between the third fastening pieces and the imaginary plane. The large sprocket includes a large toothed ring surrounding the axis, and a plurality of fourth fastening pieces connected to the large toothed ring and extending toward the axis.

Each of the first securing members extends parallel to the axis through a respective one of the first fastening pieces and a respective one of the third fastening pieces into the crank arm, so as to secure fixedly the small sprocket and the medium sprocket to the crank arm.

Each of the second securing members extends parallel to the axis through a respective one of the second fastening pieces and a respective one of the fourth fastening pieces, so as to secure fixedly the large sprocket to the medium sprocket.

### BRIEF DESCRIPTION OF THE DRAWINGS

Other features and advantages of the disclosure will become apparent in the following detailed description of the embodiments with reference to the accompanying drawings, of which:

FIG. 1 is a side view of a conventional bicycle frame;

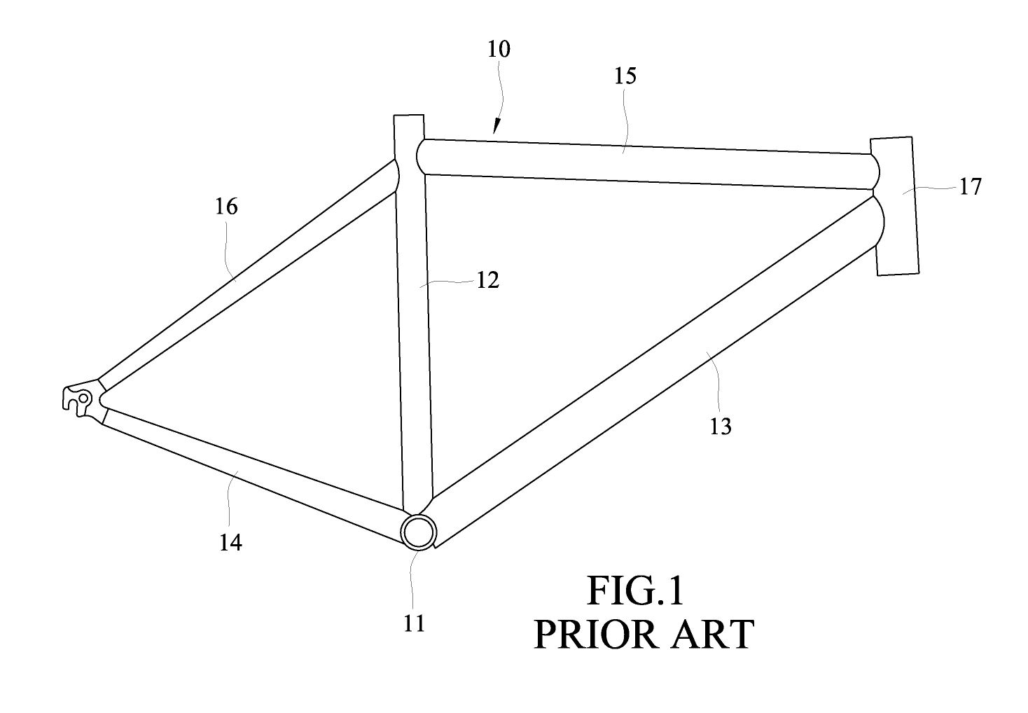

FIG. 2 is a schematic partly sectional view illustrating that a conventional crank assembly disclosed in U.S. Pat. No. 5,217,413 is mounted to a spindle;

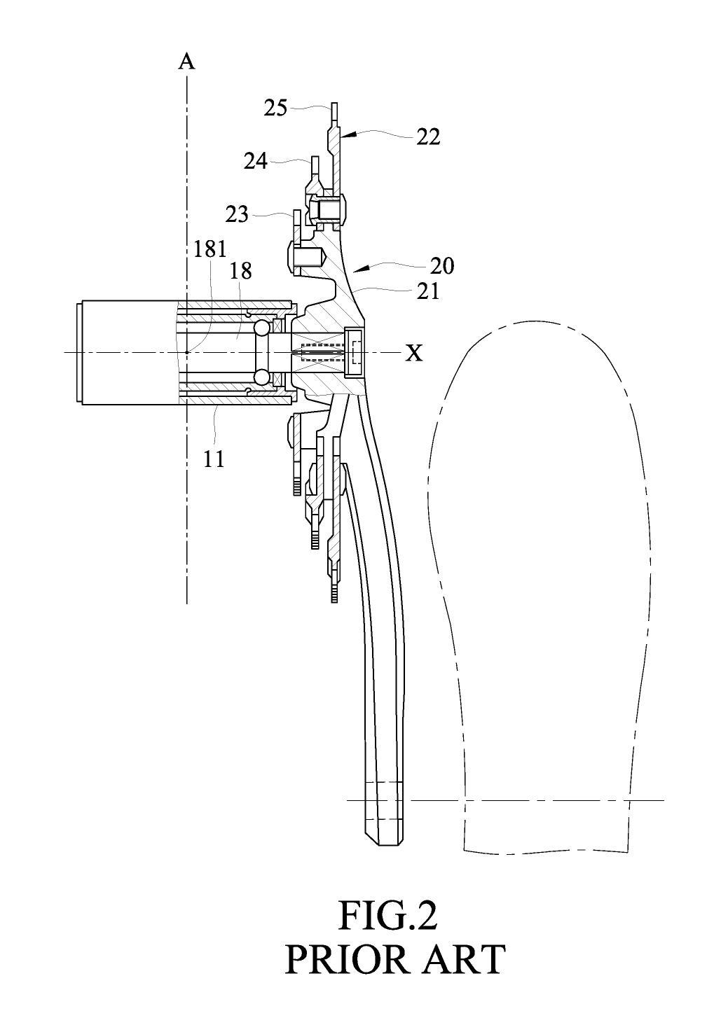

FIG. 3 is a fragmentary partly sectional view illustrating that a first embodiment of a crank assembly according to the disclosure is mounted to a spindle;

FIG. 4 is a perspective view of the first embodiment;

FIG. 5 is view similar to FIG. 4, but with a crank arm of the crank assembly omitted;

FIG. 6 is a view similar to FIG. 3, but illustrating another configuration of the crank assembly of the first embodiment;

FIG. 7 is a view similar to FIG. 3, but illustrating still another configuration of the crank assembly of the first embodiment;

FIG. 8 is a fragmentary partly sectional view illustrating that a second embodiment of a crank assembly according to the disclosure is mounted to a spindle; and

FIG. 9 is a fragmentary partly sectional view illustrating that a modification of the second embodiment is mounted to a spindle.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

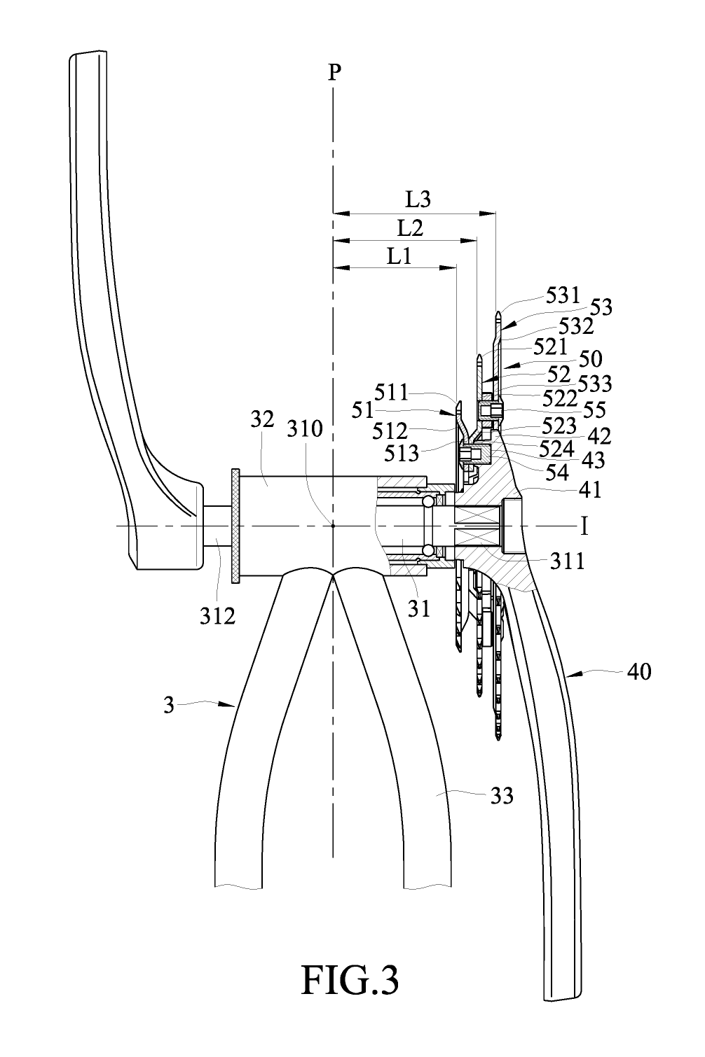

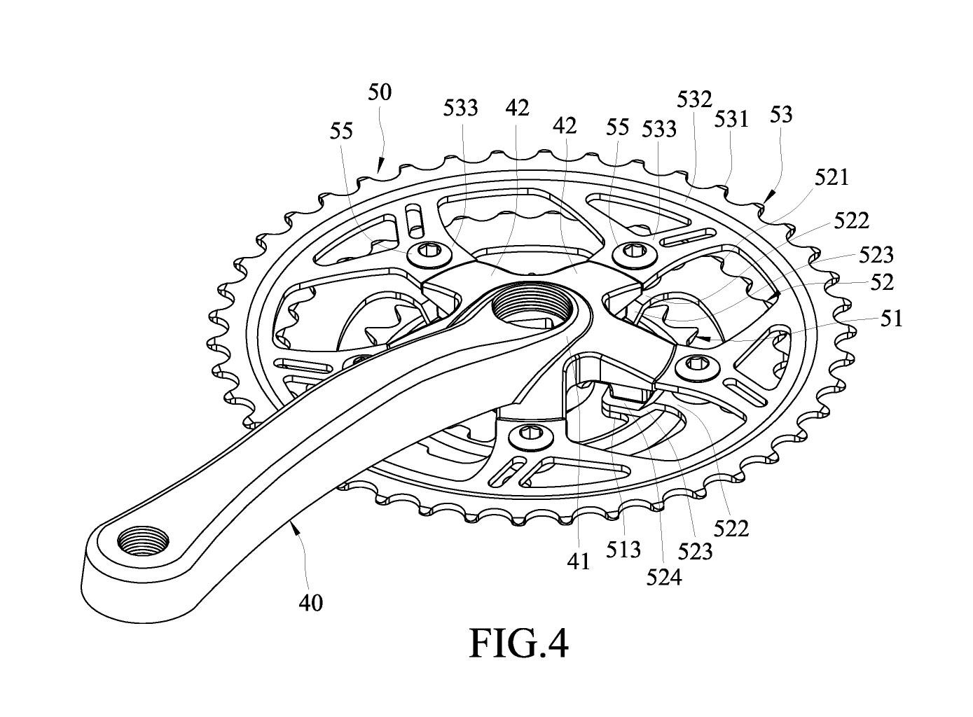

Referring to FIGS. 3 and 4, a first embodiment of a crank assembly according to the disclosure is mounted to a spindle 31 of a bicycle (not shown). The spindle 31 extends along an axis (I), is rotatable about the axis (I), and is disposed in a bottom bracket shell 32 of the bicycle. The bottom bracket shell 32, a dual chain stay 33, a seat tube (not shown) and a down tube (not shown) cooperatively form a tube structure 3 as a part of a frame of the bicycle. The spindle 31 has a center point 310 on the axis (I), and two opposite connecting segments 311, 312 located along the axis (I) and extending out of the bottom bracket shell 32. The crank assembly includes a crank arm 40, a sprocket unit 50, and a plurality of first and second securing members 54, 55.

The crank arm 40 has a connecting portion 41 that is adapted to be securely mounted to one of the connecting segments 311, 312 of the spindle 31, a plurality of angularly spaced-apart arm portions 42 that surround the axis (I) and that extend from the connecting portion 41, and a plurality of mounting grooves 43 (only one is shown) that are respectively formed in the arm portions 42.

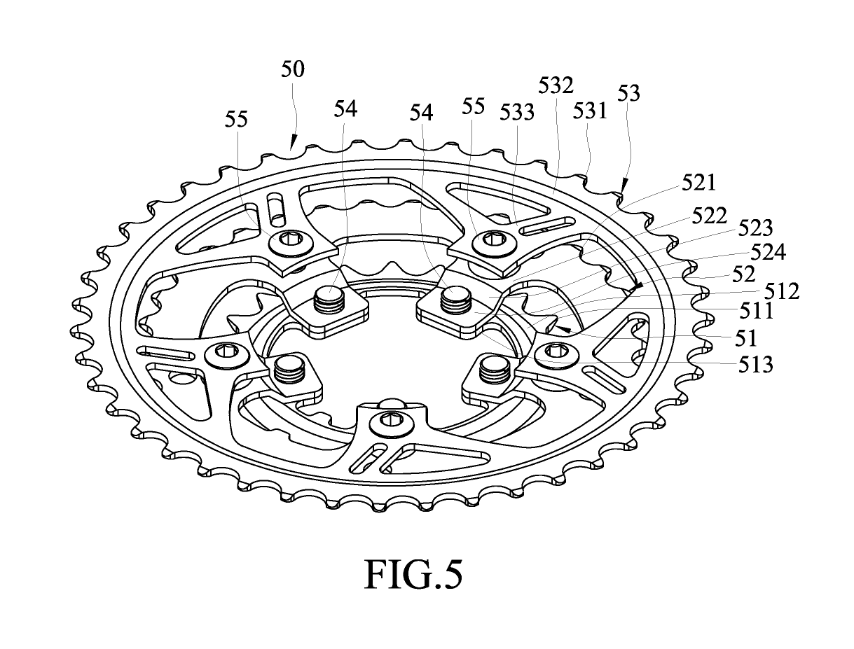

With further reference to FIG. 5, the sprocket unit 50 includes a small sprocket 51, a medium sprocket 52, and a large sprocket 53. The small sprocket 51 includes a small toothed ring 511 surrounding the axis (I), and a plurality of first fastening pieces 513 connected to the small toothed ring 511 and extending toward the axis (I). The small sprocket 51 may further include, as illustrated, a spacing-adjustment ring 512 which extends obliquely from an inner periphery of the small toothed ring 511, and from which the first fastening pieces 513 extend toward the axis (I). More specifically, the spacing-adjustment ring 512 extends away from an imaginary plane (P) (see FIG. 3) which passes through the center point 310 of the spindle 31 and which is normal to the axis (I).

The medium sprocket 52 includes a medium toothed ring 521 surrounding the axis (I), a plurality of second fastening pieces 522 extending from the medium toothed ring 521 toward the axis (I), a plurality of third fastening pieces 524 surrounding the axis (I), and a plurality of spacing-adjustment pieces 523 each interconnecting a respective one of the second fastening pieces 522 and a respective one of the third fastening pieces 524. The second fastening pieces 522 and the third fastening pieces 524 are respectively distal from and proximate to the axis (I), and parallel to the imaginary plane (P). A distance between the second fastening pieces 522 and the imaginary plane (P) is different from that between the third fastening pieces 524 and the imaginary plane (P).

In this embodiment, the spacing-adjustment pieces 523 are inclined relative to the second fastening pieces 522 toward the imaginary plane (P). In certain embodiments, the spacing-adjustment pieces 523 may be inclined relative to the second fastening pieces 522 away from the imaginary plane (P), and length of extension of the spacing-adjustment pieces 523 toward or away from the imaginary plane (P) may be altered according to actual design requirements.

The large sprocket 53 includes a large toothed ring 531 surrounding the axis (I), and a plurality of fourth fastening pieces 533 connected to the large toothed ring 531 and extending toward the axis (I). The large sprocket 53 may further include, as illustrated, a spacing-adjustment ring 532 which extends obliquely from an inner periphery of the large toothed ring 531 toward the imaginary plane (P), and from which the fourth fastening pieces 533 extend toward the axis (I).

The arm portions 42 of the crank arm 40 and the first, second, third, and fourth fastening pieces 513, 522, 524, 533 are equal in numbers (e.g., five in this embodiment), are equiangularly spaced around the axis (I), and correspond in position to one another. In this way, the arm portions 42 of the crank arm 40 are respectively aligned with the fourth fastening pieces 533, as shown in FIG. 4.

Referring to FIGS. 3 to 5, each of the first securing members 54 extends parallel to the axis (I) through a respective one of the first fastening pieces 513 and a respective one of the third fastening pieces 524 into a respective one of the mounting grooves 43 of the crank arm 40, so as to secure fixedly the small sprocket 51 and the medium sprocket 52 to the crank arm 40.

Each of the second securing members 55 extends parallel to the axis (I) through a respective one of the second fastening pieces 522 and a respective one of the fourth fastening pieces 533, so as to secure fixedly the large sprocket 53 to the medium sprocket 52.

FIG. 3 illustrates one configuration of the crank assembly, in which each of the small and large sprockets 51, 53 have the spacing-adjustment ring 512, 532. As illustrated, a distance between the small toothed ring 511 and the imaginary plane (P) is defined as the first distance (L1), a distance between the medium toothed ring 521 and the imaginary plane (P) is defined as the second distance (L2), and a distance between the large toothed ring 531 and the imaginary plane (P) is defined as the third distance (L3).

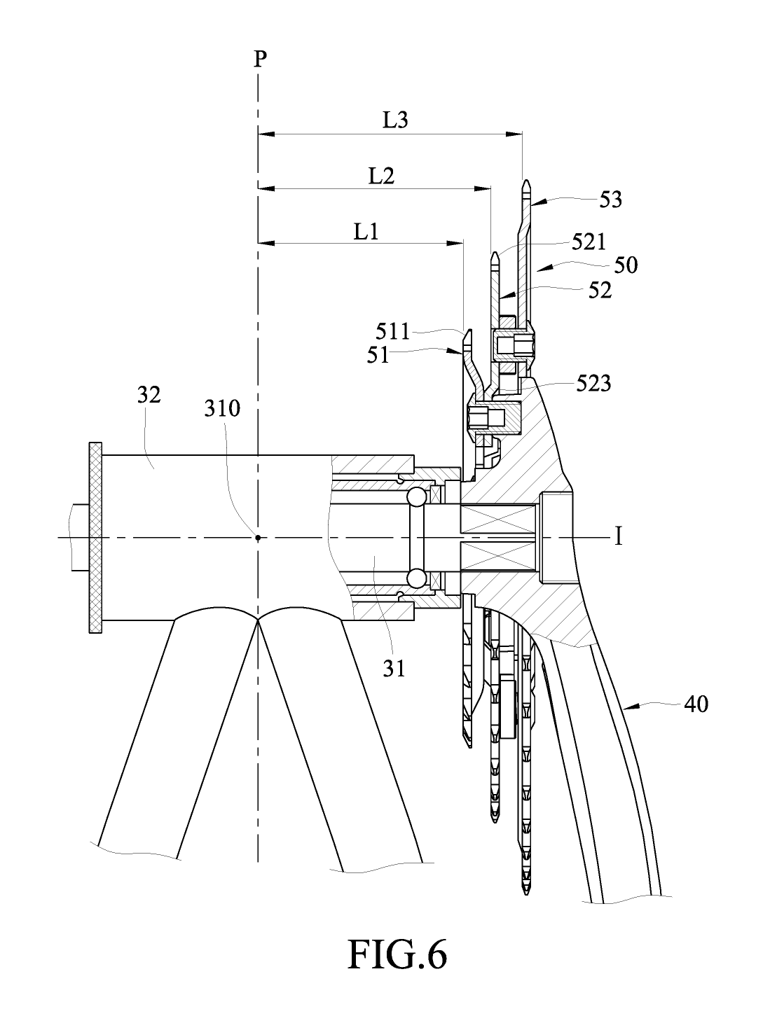

FIG. 6 illustrates another configuration of the crank assembly with the spacing-adjustment pieces 523 of the medium sprocket 52 having a shorter length of extension toward the imaginary plane (P) compared with that of the crank assembly in FIG. 3, so that the medium and large sprockets 52, 53 are closer to the imaginary plane (P). That is, the second and third distances (L2, L3) are smaller. The distance between the small and medium toothed rings 511, 521 is also smaller.

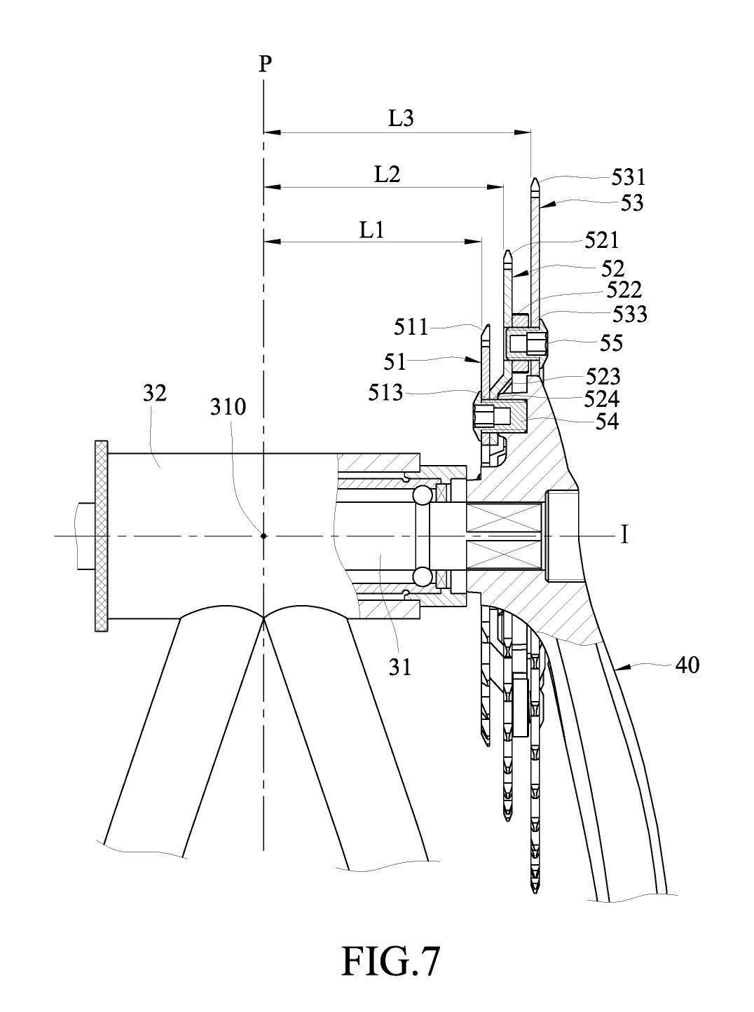

FIG. 7 illustrates still another configuration of the crank assembly, in which the spacing-adjustment rings 512, 532 of the small and large sprockets 51, 53 are omitted. As such, the first distance (L1) is larger and the third distance (L3) is smaller, and the distance between any two of the small, medium, and large toothed rings 511, 521, 531 is smaller compared with the configuration in FIG. 3.

The above-mentioned configurations of the crank assembly are exemplary configurations illustrating the first, second, and third distances (L1, L2, L3) can be changed. In actual practice, the crank assembly is not limited to the above-mentioned configurations, and other configurations with different combinations of the small, medium, and large sprockets 51, 52, 53 may be employed. With an increase in sizes of the bottom bracket shell 32 and of the spindle 31, the crank assembly can be configured with an increase in the first, second, and third distances (L1, L2, L3) according to the safety standards by selecting the suitable small, medium, and/or large sprockets 51, 52, 53. In this way, the size of the tube structure 3 (see FIG. 3) can be changed accordingly, and sizes of other components (e.g., wheels and front fork end) of the bicycle can be changed accordingly as well. In addition, chains of different sizes can be fitted onto the sprocket unit 50 by changing the distance between the small, medium, and large toothed rings 511, 521, 531.

In summary, the crank assembly of the disclosure has the following advantages:

1. The spacing-adjustment pieces 523 of the medium sprocket 52 and the spacing-adjustment rings 512, 532 of the small and large sprockets 51, 53 provide flexibility in changing the first, second, and third distances (L1, L2, L3) according to the change in sizes of the bottom bracket shell 32 and of the spindle 31. In this way, sizes of the part of the tube structure 3 and/or other components of the bicycle may be changed accordingly, for example, position of a fork end connected to a dual seat stay may be adjusted for achieving a better assembly of the bicycle. Therefore, the crank assembly of the disclosure not only can meet different bicycle design requirements but also enable manufacturers to comply with the safety standards.

2. When the sizes of the bottom bracket shell 32 and of the spindle 31 are increased, the distance between the crank arm 40 and the dual chain stay 33 can be increased by increasing the first, second and/or third distances (L1, L2, L3), thereby preventing the crank arm 40 from hitting the dual chain stay 33 during pedaling.

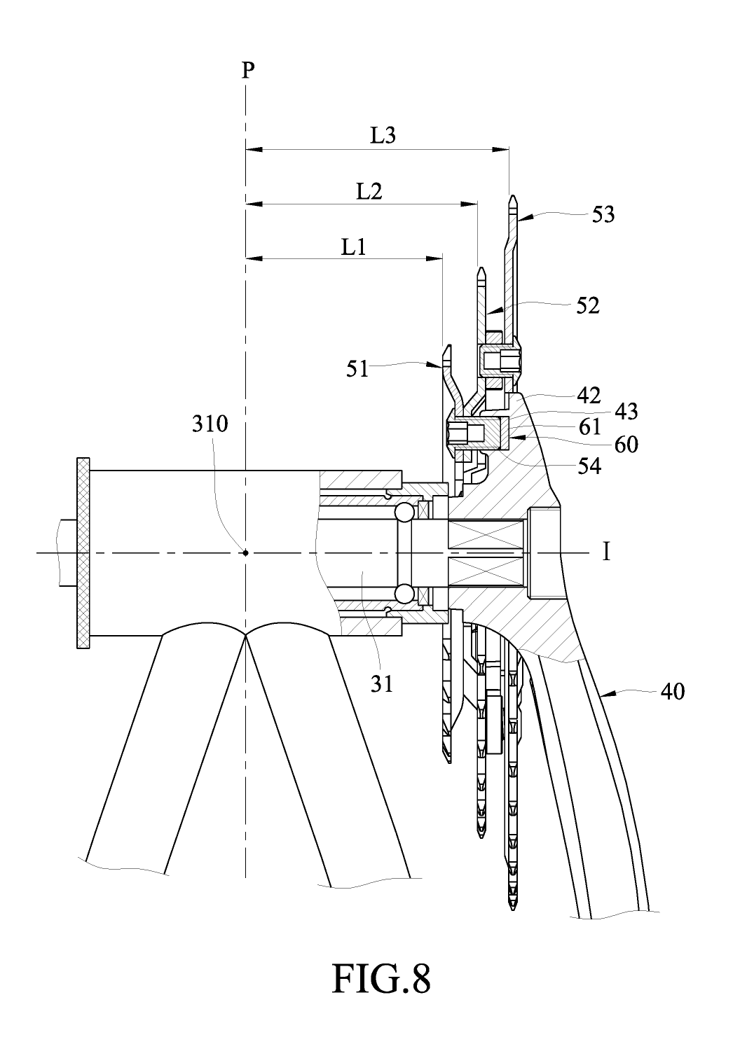

Referring to FIG. 8, a second embodiment of the crank assembly according to the disclosure is similar to the first embodiment, but further includes a plurality of adjustment units 60 (only one is shown) respectively disposed at the arm portions 42 of the crank arm 40 for adjusting length of each of the first securing members 54 in the respective one of the mounting grooves 43, so as to change the distance between the sprocket unit 50 and the imaginary plane (P). Each of the adjustment units 60 includes a spacer 61 that is disposed in a respective one of the mounting grooves 43 and that is in contact with a corresponding one of the first securing members 54. By varying the thickness of the spacers 61, the length of the first securing members 54 in the respective mounting grooves 43 can be altered so as to change the first, second, and third distances (L1, L2, L3). For example, the first, second, and third distances (L1, L2, L3) are decreased by increasing the thickness of the spacers 61.

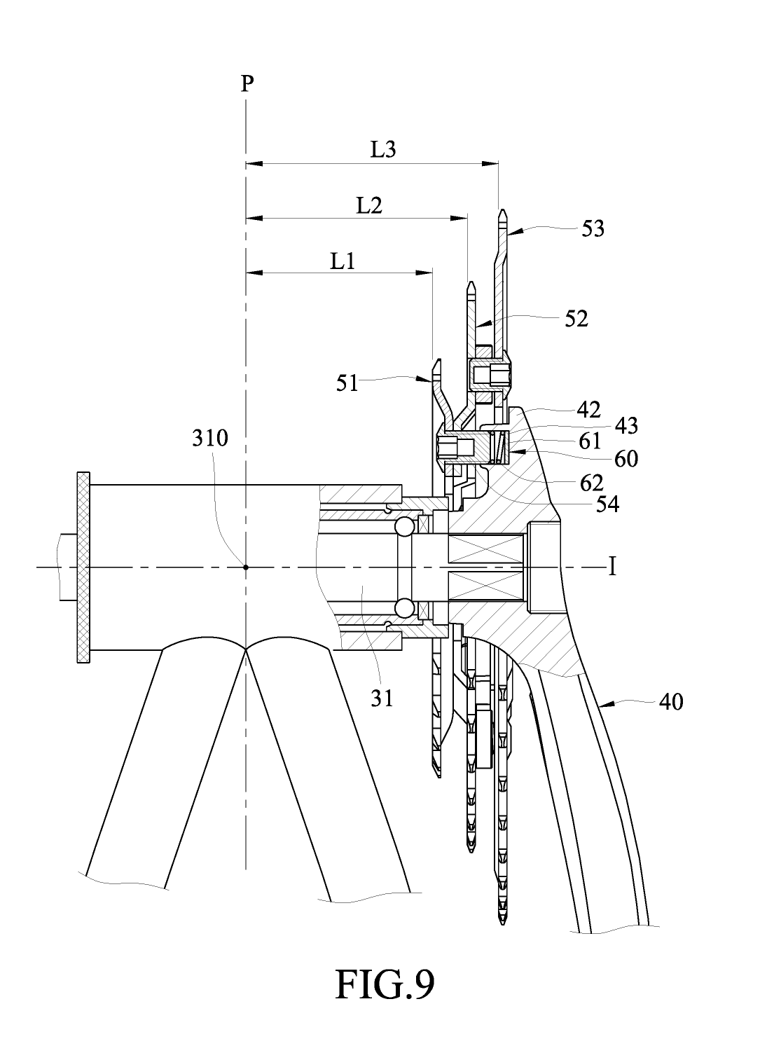

Referring to FIG. 9, in a modification of the second embodiment, each of the adjustment units 60 further includes a resilient member 62 that has two opposite ends respectively abut against the spacer 61 and a corresponding one of the first securing members 54. The resilient member 62 may be configured as a compression spring. By virtue of the adjustment units 60, the length of the first securing members 54 in the respective mounting grooves 43 can be adjusted, thereby enabling minor adjustment of the first, second, and third distances (L1, L2, L3). Moreover, minor dimensional error of the components of the crank assembly may be compensated by the adjustment units 60.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A crank assembly for a bicycle, the bicycle including a spindle that extends along an axis, and that has a center point on the axis and two opposite connecting segments along the axis, said crank assembly comprising:
a crank arm adapted to be mounted to one of the connecting segments of the spindle;
a sprocket unit including
a small sprocket that includes a small toothed ring surrounding the axis, and a plurality of first fastening pieces connected to said small toothed ring and extending toward the axis,
a medium sprocket that includes
a medium toothed ring surrounding the axis,
a plurality of second fastening pieces extending from said medium toothed ring toward the axis,
a plurality of third fastening pieces surrounding the axis, said second fastening pieces and said third fastening pieces being respectively distal from and proximate to the axis, and
a plurality of spacing-adjustment pieces, each interconnecting a respective one of said second fastening pieces and a respective one of said third fastening pieces, a distance between said second fastening pieces and an imaginary plane which passes through the center point of the spindle and which is normal to the axis being different from that between said third fastening pieces and the imaginary plane, and
a large sprocket that includes a large toothed ring surrounding the axis, and a plurality of fourth fastening pieces connected to said large toothed ring and extending toward the axis;
a plurality of first securing members, each extending parallel to the axis through a respective one of said first fastening pieces and a respective one of said third fastening pieces into said crank arm, so as to secure fixedly said small sprocket and said medium sprocket to said crank arm; and
a plurality of second securing members, each extending parallel to the axis through a respective one of said second fastening pieces and a respective one of said fourth fastening pieces, so as to secure fixedly said large sprocket to said medium sprocket.

2. The crank assembly as claimed in claim 1, wherein said third fastening pieces and said second fastening pieces are parallel to the imaginary plane.

3. The crank assembly as claimed in claim 1, wherein said spacing-adjustment pieces of said medium sprocket are inclined relative to said second fastening pieces toward the imaginary plane.

4. The crank assembly as claimed in claim 3, wherein said small sprocket further includes a spacing-adjustment ring which extends obliquely from an inner periphery of said small toothed ring away from the imaginary plane, and from which said first fastening pieces extend toward the axis.

5. The crank assembly as claimed in claim 4, wherein said large sprocket further includes a spacing-adjustment ring which extends obliquely from an inner periphery of said large toothed ring toward the imaginary plane, and from which said fourth fastening pieces extend toward the axis.

6. The crank assembly as claimed in claim 5, wherein:
said crank arm has a connecting portion that is adapted to be securely mounted to the one of the connecting segments of the spindle, and a plurality of arm portions that surround the axis, that extend from said connecting portion and that are respectively aligned with said fourth fastening pieces, and a plurality of mounting grooves that are respectively formed in said arm portions; and
each of said first securing members extends through the respective one of said first fastening pieces and the respective one of said third fastening pieces into a respective one of said mounting grooves so as to secure fixedly said small sprocket and said medium sprocket to said crank arm.

7. The crank assembly as claimed in claim 6, further comprising a plurality of adjustment units respectively disposed at said arm portions of said crank arm for adjusting length of each of said first securing members in the respective one of said mounting grooves.

8. The crank assembly as claimed in claim 7, wherein each of said adjustment units includes a spacer that is disposed in a respective one of said mounting grooves and that is in contact with a corresponding one of said first securing members.

9. The crank assembly as claimed in claim 7, wherein each of said adjustment units includes a spacer that is disposed in a respective one of said mounting grooves, and a resilient member that has two opposite ends respectively abut against said spacer and a corresponding one of said first securing members.

10. The crank assembly as claimed in claim 3, wherein said large sprocket further includes a spacing-adjustment ring which extends obliquely from an inner periphery of said large toothed ring toward the imaginary plane, and from which said fourth fastening pieces extend toward the axis.

11. The crank assembly as claimed in claim 10, wherein:
said crank arm has a connecting portion that is adapted to be securely mounted to the one of the connecting segments of the spindle, and a plurality of arm portions that surround the axis, that extend from said connecting portion and that are respectively aligned with said fourth fastening pieces, and a plurality of mounting grooves that are respectively formed in said arm portions; and
each of said first securing members extends through the respective one of said first fastening pieces and the respective one of said third fastening pieces into a respective one of said mounting grooves so as to secure fixedly said small sprocket and said medium sprocket to said crank arm.

12. The crank assembly as claimed in claim 11, further comprising a plurality of adjustment units respectively disposed at said arm portions of said crank arm for adjusting length of each of said first securing members in the respective one of said mounting grooves.

13. The crank assembly as claimed in claim 12, wherein each of said adjustment units includes a spacer that is disposed in a respective one of said mounting grooves and that is in contact with a corresponding one of said first securing members.

14. The crank assembly as claimed in claim 12, wherein each of said adjustment units includes a spacer that is disposed in a respective one of said mounting grooves, and a resilient member that has two opposite ends respectively abut against said spacer and a corresponding one of said first securing members.
